(19) United States
(12) Patent Application Publication
(10) Pub. No.: US 2025/0200502 A1
(43) Pub. Date: Jun. 19, 2025

(54) DELIVERY SYSTEM AND METHOD OF SECURELY DELIVERING A PACKAGE

(71) Applicant: Matthew Warner, Los Angeles, CA (US)

(72) Inventor: Matthew Warner, Los Angeles, CA (US)

(21) Appl. No.: 18/981,410

(22) Filed: Dec. 13, 2024

Related U.S. Application Data
(60) Provisional application No. 63/610,450, filed on Dec. 15, 2023.

(51) Int. Cl. G06Q 10/0836; A47G 29/12; G07C 9/00

(52) U.S. Cl. CPC G06Q 10/0836; A47G 29/12; G07C 9/00571

(57) ABSTRACT

A delivery system and method of securely delivering a package is disclosed. The delivery system includes housings positioned at a wall or door of a structure. Each housing is separated by a function. The housings are used for receiving food and groceries, and packages. Each housing is unlocked separately by a specific security code or Quick Response (QR) code scan via a keypad. When a delivery provider approaches, the delivery system prompts to type in the security code issued at the time of a shipment order. The security code entered is authenticated to allow access to the appropriate housing for delivery drop-off. The delivery system ensures only authorized delivery providers gain access to deliver the packages and/or food and groceries. The delivery system includes an image capturing unit for capturing images and providing a real-time knowledge of when the delivery is made to the owner or intended recipient.

The present application claims the benefit of U.S. Provisional Application No. 63/610,450, filed Dec. 15, 2023; all of which is incorporated herein and referenced thereto.

### FIELD OF THE INVENTION

The present invention relates to delivering packages. More specifically, the present invention relates to a delivery system having automated and remotely controlled features for secure delivery of packages.

### BACKGROUND OF THE INVENTION

With the increase in technology, many people tend to use electronic commerce (e-commerce) sites created by web technology to buy goods or items. The e-commerce sites, often referred to as, online shops allow a person to purchase an item or goods. After purchase, the item is delivered to a designated delivery destination specified by the purchaser. Typically, e-commerce sites use a delivery company to deliver the item at the designated delivery destination. At times, the person intended to receive the item at the designated delivery destination may be away from the designated delivery destination. This results in a missed delivery. In some instances, a representative of the delivery company may leave the item at the doorstep. The item or package left at the doorstep is susceptible to theft or damage. Further, the item may get damaged due to weather conditions.

In order to overcome the above problems, several devices have been proposed in the past. One such attempt is disclosed in a U.S. Pat. No. 11,666,168, entitled “Food delivery receptacle assembly” (“the '168 Patent”). The '168 Patent discloses a food delivery receptacle assembly for protecting food deliveries including a box in which a set of openings is positioned. A food container can be inserted into the box through a respective opening. Each of a set of panels is hingedly engaged to the box and is positioned to selectively close a respective opening. Insulation is engaged to an inner surface of the box and to an inner face of each panel. The insulation reduces heat transfer between food in the food container and air outside of the box. Each of a set of locks is engaged to the box and is selectively engageable to a respective panel. The locks are electronically actuated to deter unauthorized access to the food container. The locks can be deactivated to permit authorized access to the food container, thus allowing access to the box by a delivery agent and a user.

Another example is disclosed in a U.S. Pat. No. 11,064,831, entitled “Package delivery system and method of use” (“the '831 Patent”). The '831 Patent discloses a package delivery system including a delivery pod container having a package deposit door positioned at a top of the delivery pod container, the package deposit door providing access to an interior area of the delivery pod container; and a pod door located on a front of the delivery pod container and to provide access to the interior area of the delivery pod container, the pod door having a lock; a bracket attached to the delivery pod container and to engage with a door and mount the delivery pod container thereto; the delivery pod container is to receive the package therein upon delivery from the delivery personnel.

Yet another example is disclosed in a U.S. Pat. No. 10,039,401, entitled “Smart parcel safe” (“the '401 Patent”). The '401 Patent discloses a smart parcel safe including a container defining an enclosure with an opening, a lid attached to the container by hinges and formed to fit over the opening and securely close the enclosure in a closed orientation, the lid being hinged to move from the closed orientation into an open orientation so as to provide access to the enclosure through the opening, a mobile communication device including an app designed to control locking/unlocking of an associated locking mechanism, and an electronically controlled locking mechanism affixed to the container and the lid, the electronically controlled locking mechanism being associated with the mobile communication device so as to be locked/unlocked in response to operation of the mobile communication device.

Although the above discussed delivery receptacles are useful, they have few problems. For instance, most of the existing delivery receptacles are designed for receiving specific goods such as packages or perishable items. As such, the delivery receptacles used for receiving the packages are not suitable to store the perishable items for a long-time resulting in the perishable items to get spoiled if left unattended. Further, some of the existing delivery receptacles do not offer intended security features and real-time notifications to the owner or intended recipient.

Therefore, there is a need in the art to provide an improved delivery system that is equipped with security features, configured to control internal temperature allowing to protect perishable goods or medications and offer a built-in communication system to notify the intended recipient when a delivery is made.

### SUMMARY

It is an object of the present subject matter to provide a delivery system and that avoids the drawbacks of known delivery receptacles.

It is another object of the present subject matter to provide a delivery system having multiple housings or receptacles, each separated by a function and configured to receive food and groceries, and packages.

It is another object of the present subject matter to provide a delivery system that is equipped with security features, configured to control internal temperature allowing to protect perishable goods or medications and offer a built-in communication system to notify the intended recipient when a delivery is made.

In order to overcome one or more objects, the present subject matter presents a delivery system and a method of securely delivering a package. The delivery system includes housings positioned at a wall or door of a structure. Each housing is separated by a function. The housings are used for receiving food and groceries, and packages. Each housing is unlocked separately by a specific security code or Quick Response (QR) code scan via a keypad. When a delivery provider approaches, the delivery system prompts to type in the security code issued at the time of a shipment order. The security code entered is authenticated to allow access to the appropriate housing for delivery drop-off. The delivery system ensures only authorized delivery providers gain access to deliver the packages and/or food and groceries. The delivery system includes an image capturing unit for capturing images and providing a real-time knowledge of when the delivery is made to the owner or intended recipient.

In one advantageous feature of the present subject matter, the delivery system is split into three compartments, each separated by a function. The upper two compartments are used for food and groceries and the lower compartment is used for packages. The upper compartments are temperature controlled. As such, the owner of the delivery system can set the temperature to keep the item (food and grocery) at a certain temperature until the item is taken out of the compartment.

In another advantageous feature of the present subject matter, the delivery system includes an image capturing unit installed above the compartments or housings. The image capturing unit provides a real-time knowledge of when the delivery is made to the owner or intended recipient and helps to prevent thefts, and present an extra security measure to their home.

In another advantageous feature of the present subject matter, the delivery system can be customized to blend it into the tile, wood, or brick surrounding it. The delivery system can be customised to appear as a piece of furniture (elegant armoire, cupboard, cabinet) helping it to blend seamlessly into the home.

The features and advantages of the subject matter here will become more apparent in light of the following detailed description of selected embodiments, as illustrated in the accompanying FIGURES. As will be realized, the subject matter disclosed is capable of modifications in various respects, all without departing from the scope of the subject matter. Accordingly, the drawings and the description are to be regarded as illustrative in nature.

### BRIEF DESCRIPTION OF THE DRAWINGS

A more complete understanding of the invention and its many advantages thereof will be readily appreciated as the same becomes better understood by reference to the following detailed description, when considered in connection with the accompanying drawings wherein:

FIG. 1 illustrates an environment in which a delivery system implements, in accordance with one embodiment of the present subject matter;

FIG. 2 illustrates the delivery system placed at a wall of a structure, in accordance with one exemplary embodiment of the present subject matter;

FIG. 3 illustrates a block diagram of the delivery system, in accordance with one embodiment of the present subject matter;

FIG. 4 illustrates a block diagram of the delivery system being operated by a second device based on access code received from a first device, in accordance with one embodiment of the present subject matter;

FIG. 5 illustrates a block diagram of a server, in accordance with one embodiment of the present subject matter; and

FIG. 6 illustrates a method of securely delivering a package, in accordance with one embodiment of the present subject matter.

### DETAILED DESCRIPTION

The following detailed description set forth below in connection with the appended drawings is intended as a description of exemplary embodiments in which the presently disclosed subject matter may be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed delivery system. However, it will be apparent to those skilled in the art that the presently disclosed subject matter may be practiced without these specific details. In some instances, well-known structures and devices are shown in functional or conceptual diagram form in order to avoid obscuring the concepts of the presently disclosed delivery system.

In the present specification, an embodiment showing a singular component should not be considered limiting. Rather, the subject matter preferably encompasses other embodiments including a plurality of the same component, and vice-versa, unless explicitly stated otherwise herein. Moreover, the applicant does not intend for any term in the specification to be ascribed an uncommon or special meaning unless explicitly set forth as such. Further, the present subject matter encompasses present and future known equivalents to the known components referred to herein by way of illustration.

Although the present subject matter provides a description of a delivery system, it is to be further understood that numerous changes may arise in the details of the embodiments of the delivery system. It is contemplated that all such changes and additional embodiments are within the spirit and true scope of this disclosure.

The following detailed description is merely exemplary in nature and is not intended to limit the described embodiments or the application and uses of the described embodiments. All of the implementations described below are exemplary implementations provided to enable persons skilled in the art to make or use the embodiments of the disclosure and are not intended to limit the scope of the disclosure.

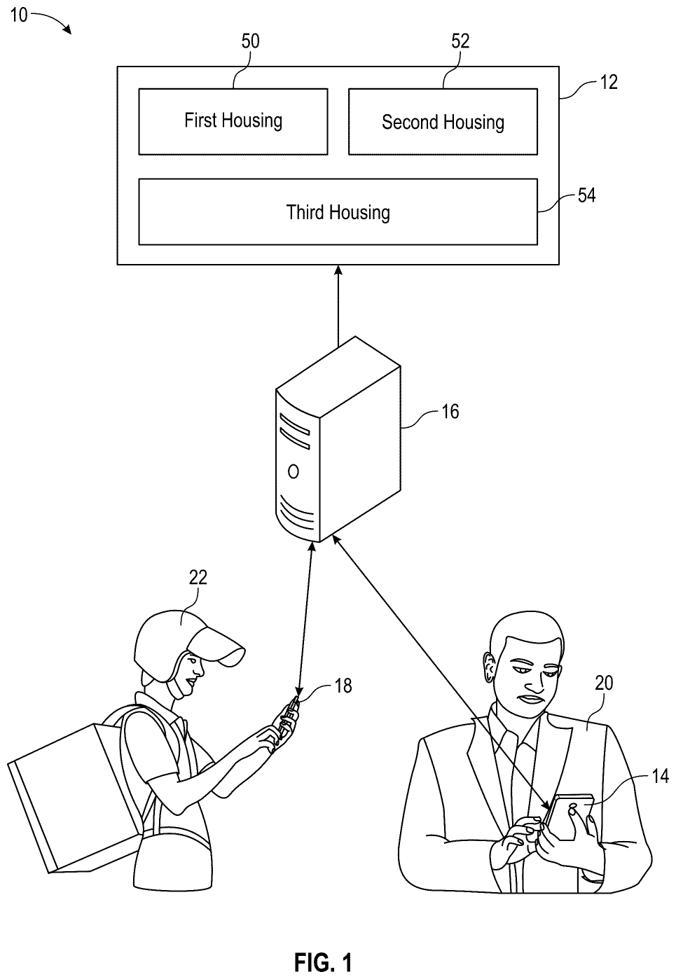

Various features and embodiments of a delivery system for securely delivering a package are explained in conjunction with the description of FIGUREs (FIGS. 1-6.

FIG. 1 shows an environment 10 in which a delivery system 12 implements, in accordance with one embodiment of the present subject matter. Delivery system 12 communicatively 12 connects to a first device 14, a server 16 and a second device 18 via a network (not shown). The network includes a wireless network, a wired network or a combination thereof. The network can be implemented as one of the different types of networks, such as intranet, local area network (LAN), wide area network (WAN), the internet, and the like. The network implements as a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the network includes a variety of network devices, including routers, bridges, servers, computing devices, storage devices, and the like.

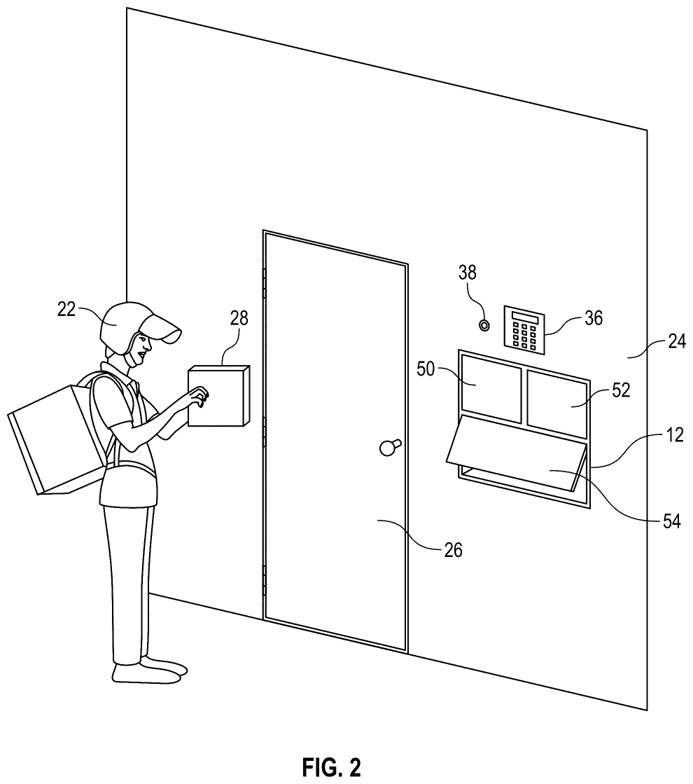

Delivery system 12 installs at a wall 26 or specifically designed cabinet near a door of a structure or home or building 24, as shown in FIG. 2, for example. In one example, delivery system 12 is installed flushing with structure 24 to save space at structure 24. Optionally, delivery system 12 is designed to integrate within the wall of structure 24. First device 14 indicates an electronic device such as a mobile phone, a laptop, a computer, a personal digital assistant device, etc. First device 14 is operated by a first user e.g., owner 20 of structure 24. Second device 18 indicates an electronic device such as a mobile phone, a laptop, a computer, a personal digital assistant device, etc. Second device 18 is operated by a second user 22 i.e., delivery agent of a delivery company.

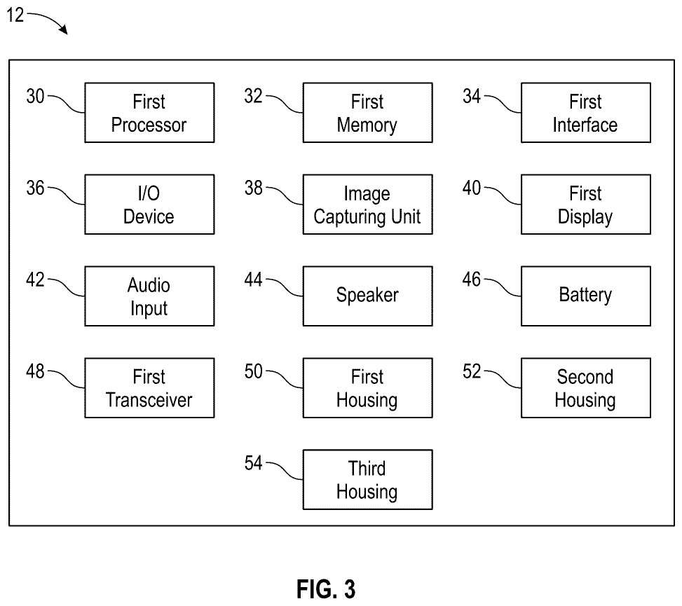

FIG. 3 shows a block diagram of delivery system 12, in accordance with one embodiment of the present subject matter. Delivery system 12 includes a first processor 30. First processor 30 includes one or more commonly known CPUs such as a microprocessor or a microcontroller. It should be understood that first processor 30 is responsible for implementing specific functions under the control of software including an operating system, and any appropriate applications software. Delivery system 12 includes a first memory 32 such as a volatile memory (e.g., RAM), non-volatile memory (e.g., disk memory, FLASH memory, EPROMs, etc.), unalterable memory, and/or other types of memory. In one implementation, first memory 32 is configured or designed to store data, program instructions. The program instructions control the operation of an operating system and/or one or more applications. Delivery system 12 includes a first interface 34. First interface 34 includes a wired interface and/or a wireless interface. In one implementation, first interface 34 includes functionality similar to at least a portion of functionality implemented by one or more computer system interfaces such as those described herein and/or generally known to one having ordinary skill in the art. Delivery system 12 includes an Input/Output (I/O) device 36 such as a keypad, buttons, toggles, etc.

Further, delivery system 12 includes an image capturing unit 38 such as a camera for capturing image or video of second user 22, or package 28 being placed at delivery system 12. In one example, image capturing unit 38 is positioned adjacent to delivery system 12 (or housing 50, 52, 54) for capturing images or videos of package 28 and/or second user 22 at the time of delivery of items. Delivery system 12 includes a first display 40 for displaying text, digital keypad, image or video. Delivery system 12 includes an audio input 42 such as a microphone for capturing the voice of second user 22. Delivery system 12 includes a speaker 44 for producing sounds or for announcing audio instructions.

Delivery system 12 includes a battery 46. Battery 46 indicates a rechargeable battery such as a Lithium Ion (Li-ion) battery. Battery 46 is charged using a cable (not shown) via a charging port (not shown). Optionally, battery 46 is charged wirelessly using inductive charging or charging pad (not shown) as known in the art. Further, delivery system 12 includes a first wireless communication module(s)/transceiver 48. First transceiver 48 is configured to communicate with external devices using one or more wireless interfaces/protocols such as, for example, 802.11 (Wi-Fi), 802.15 (including Bluetooth™), 802.15 (Wi-Max), 802.22, Cellular standards such as CDMA, CDMA2000, WCDMA, Radio Frequency (e.g., RFID), Infrared, Near Field Magnetics, etc.

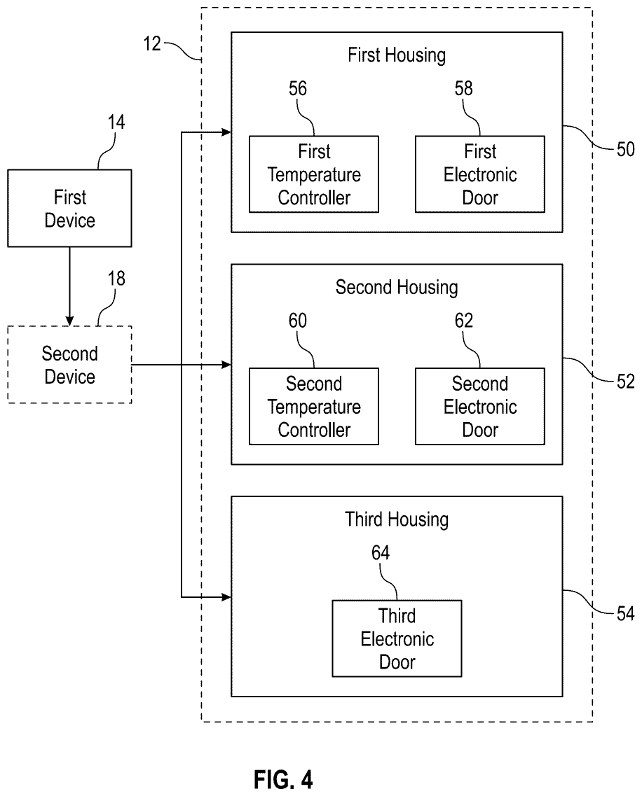

In the present subject matter, delivery system 12 includes three housings such as a first housing 50, a second housing 52 and a third housing 54. Each housing indicates a container or compartment or receptacle or storage box. In one embodiment, first housing 50 and second housing 52 position adjacent to each other and third housing 54 positions below first housing 50 and second housing 52, as can be seen from FIG. 1 and FIG. 2. As can be seen, third housing 54 is larger in size than first housing 50 and second housing 52. In one example, first housing 50 includes a first temperature controller 56, as shown in FIG. 4. First temperature controller 56 helps to maintain temperature inside first housing 50. Further, first housing 50 includes a first electronic door 58. First processor 30 controls the operation of first electronic door 58 to provide access or restrict to first housing 50. Similarly, second housing 52 includes a second temperature controller 60. Second temperature controller 60 helps to maintain temperature inside second housing 52. Further, second housing 52 includes a second electronic door 62. First processor 30 controls the operation of second electronic door 62 to provide access or restrict to second housing 52. Further, third housing 54 includes a third electronic door 64. First processor 30 controls the operation of second electronic door 62 to provide access or restrict to second housing 52.

In one example, first temperature controller 56 and second temperature controller 60 help to heat and/or refrigerate first housing 50 and second housing 52, respectively with variable temperatures such that first user 20 may set the temperature of first housing 50 and second housing 52 between 32 and 158 degrees Fahrenheit separately. This presents first user 20 with the ability to pre-set, activate, and isolate first housing 50 and second housing 52 based on the type of item(s) being stored remotely. In one example, first housing 50 allows storing food items such as pizza, wings, and other ordered foods in a pre-set temperature once they are placed inside. First housing 50 having first temperature controller 56 allows food to be ordered and delivered before anyone is home and prevents first user 20 or other occupants of structure 24 from having to rush after school, work, etc. in order to keep their food from getting cold. In another example, second housing 52 allows storing perishable items such as groceries. Here, second temperature controller 60 allows maintaining the temperature of groceries at pre-set temperature such that items can be stored while first user 20 or other occupants of structure 24 are away. Once occupants of structure 24 arrive, they move the groceries from second housing 52 into a main refrigerator (not shown) without having to worry about their food or groceries spoiling if not reached and put away immediately. Third housing 54 positions below first housing 50 and second housing 52 and is configured to receive packages 28, say delivery of physical goods such as clothing articles, books, or any other items.

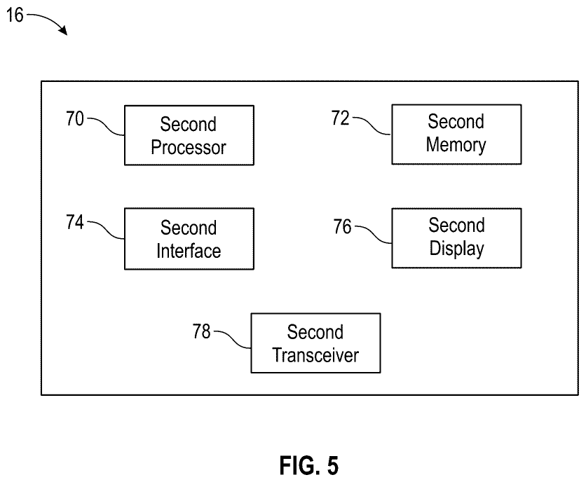

FIG. 5 shows a block diagram of server 16, in accordance with one embodiment of the present subject matter. Server 16 encompasses a second processor 70. Second processor 70 includes one or more commonly known CPUs such as a microprocessor or a microcontroller. It should be understood that second processor 70 is responsible for implementing specific functions under the control of software including an operating system, and any appropriate applications software. Server 16 includes a second memory 72 connected to second processor 70 via a data bus (not shown). Second memory 72 includes a volatile memory and/or a non-volatile memory. Preferably, second memory 72 stores program instructions or software programs that interact with the other devices such as server 16 as described below. In one implementation, second processor 70 executes the program instructions stored in second memory 72 in any suitable manner. In one implementation, second memory 72 stores digital data indicative of documents, files, programs, web pages, etc. retrieved from server 16.

Server 16 includes a second interface 74. Second interface 74 includes a wired interface and/or a wireless interface. In one implementation, second interface 74 includes functionality similar to at least a portion of functionality implemented by one or more computer system interfaces such as those described herein and/or generally known to one having ordinary skill in the art. In some examples, server 16 includes a second display 76. Further, server 16 includes a second wireless communication module(s)/transceiver 78. Second transceiver 78 is configured to communicate with external devices using one or more wireless interfaces/protocols such as, for example, 802.11 (Wi-Fi), 802.15 (including Bluetooth™), 802.15 (Wi-Max), 802.22, Cellular standards such as CDMA, CDMA2000, WCDMA, Radio Frequency (e.g., RFID), Infrared, Near Field Magnetics, etc.

In accordance with present subject matter, first device 14 accesses server 16 to purchase an item from an electronic commerce (e-commerce) site using an application. Similarly, second device 18 includes an application for receiving a service request for delivering the item at a designated delivery destination i.e., home 24 of first user 20. In order to purchase the item, at first, first user 20 registers with server 16 using his/her name, physical address, electronic mail (email) and identification number (ID). Further, first user 20 registers his/her first device 14. After registering, server 16 generates a unique user ID for first user 20 and/or first device 14. Similarly, second user 22 registers with server 16 using his/her name, physical address, employee/service provider identification number (ID), etc. Further, second user 22 registers his/her second device 18. After registering, server 16 generates a unique service provider ID for second user 22 and/or second device 18.

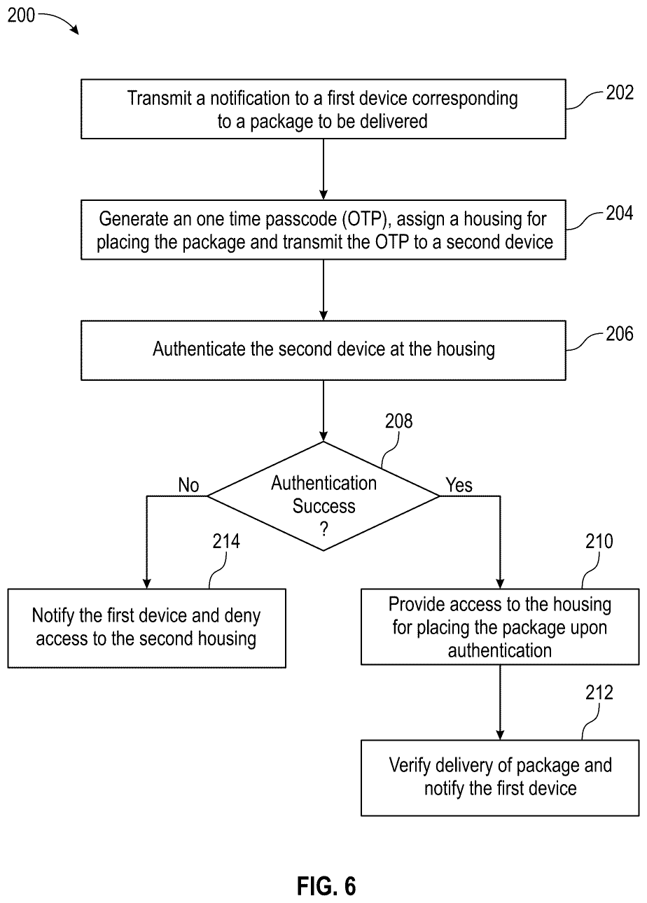

Now referring to FIG. 6, a method 200 of securely delivering a package is explained with the help of FIG. 4, in accordance with one exemplary embodiment of the present subject matter. The order in which method 200 is described should not be construed as a limitation, and any number of the described method blocks can be combined in any order to implement method 200 or alternate methods. Additionally, individual blocks may be deleted from method 200 without departing from the spirit and scope of the subject matter described herein. Furthermore, method 200 can be implemented in any suitable hardware, software, firmware, or combination thereof. However, for ease of explanation, in the embodiments described below, method 200 may be implemented using the above-described delivery system 12 and server 16.

Method 200 starts at step 202. At step 202, first user 20 purchases an item at an e-commerce site via server 16. Here, first user 20 purchases the item and makes the payment. As known, first user 20 makes the payment and provides a designated delivery destination to deliver the item. Once the order is ready to be shipped, server 16 transmits a notification to first user 20 at first device 14. Concurrently or consecutively, server 16 assigns second user 22 for delivering the item at the designated delivery destination. In one example, first user 20 determines a housing i.e., one of first housing 50, second housing 52 and third housing 54 to be used for delivering the item. As specified above, first user 20 determines the housing to be used for delivery of the item based on the type of item ordered. Considering the above example, once first user 20 selects the housing, say third housing 54 for delivering the item, then first user 20 has an option of generating a one-time passcode (OTP) to be shared with second user 22 for accessing third housing 54. In another example, server 16 generates the OTP or any other security code for second user 22 for accessing third housing 54. After generating the OTP, server 16 transmits the OTP to second device 18, as shown at step 204. At step 206, second device 18 is authenticated when second user 22 reaches delivery system 12. Upon reaching, delivery system 12 prompts second user 22 to enter the OTP or scan the QR code in order to authenticate second device 18. In one example, delivery system 12 prompts second user 22 with a numeric keypad to authenticate second device 18. In another example, delivery system 12 prompts second user 22 with a quick response (QR) to authenticate. Upon entering OTP or scanning the QR code, delivery system 12 transmits the OTP to server 16 for verifying whether the OTP entered matches with the OTP generated, as shown at step 208. If the OTP matches, then method 200 moves to step 210. At step 210, delivery system 12 receives a confirmation notification from server 16 and provides access to third housing 54. Here, delivery system 12 prompts third electronic door 64 to open such that second user 22 can place the item in third housing 54. In case the item to be delivered is food item in first housing 50, then first user 20 defines the temperature to be set inside first housing 50 for maintaining the temperature inside first housing 50 to keep the food fresh.

In one example, electronic doors 58, 62, 64 are equipped with electronic mechanical locks that only open “one way”. In other words, electronic doors 58, 62, 64 include inside or interior locks that cannot be unlocked until all of the exterior (outside the home) compartments are closed and vice versa. This prevents home invasion should an exterior threat attempt to target delivery system 12 as a means to break in. Additionally, this strategically prevents unwarranted access from vulnerable individuals within the home such as children, senior citizens, or unsuspecting guests that could be injured via heat, cold, or mechanical injury from delivery system 12 itself.

After second user 22 places the item, first processor 30 prompts image capturing unit 38 to capture an image of the item in the housing. In one example, first processor 30 prompts image capturing unit 38 to capture an image of second user 22 while he/she is delivering the item in the housing (third housing 54). Subsequently, first processor 30 employs third electronic door 64 to close indicating that the item has been securely placed in third housing 54. Subsequently, delivery system 12 notifies server 16 that the item has been delivered. Further, server 16 notifies first user 20 at first device 14 that the item has been delivered, as shown at step 212. In accordance with the present subject matter, delivery system 12 transmits live images or video captured by image capturing unit 38 to first device 14 via server 16, from the time image capturing unit 38 captures presence of second device 18 in proximity to delivery system 12 and until second user 22 completes the delivery.

If the OTP entered or QR code scanned does not match with the OTP/QR code generated at step 208, then method 200 moves to step 214. At step 214, delivery system 12 presents a notification on first display 40 that OTP/QR code entered has failed. Further, delivery system 12 notifies server 16 of incorrect OTP and the same is notified to first user 20 on first device 14. Transmission of failed authentication notification ensures unauthorised personnel from accessing delivery system 12.

The presently disclosed delivery system provides several advantages over the prior art. The delivery system has at least two compartments or housings, each separated by a function. The upper compartment(s) can be used for food and groceries, and the lower compartment is used for packages. Each compartment is unlocked separately by a specific security code or QR code scan via a keypad. The delivery provider or personnel approaches the front door and the delivery system, typing in the code or scanning the barcode that is issued at the time of the shipment order. The unique code allows the delivery provider access to the appropriate compartment for delivery drop-off. This ensures that only authorized individuals can gain access to the delivery system. The image capturing unit provides the owner real-time knowledge of when the delivery is made, prevent thefts, and add an extra security measure to their home.

A person skilled in the art appreciates that the wearable device can come in a variety of shapes and sizes depending on the need and comfort of the user. Further, many changes in the design and placement of components may take place without deviating from the scope of the presently disclosed wearable device.

In the above description, numerous specific details are set forth such as examples of some embodiments, specific components, devices, methods, in order to provide a thorough understanding of embodiments of the present subject matter. It will be apparent to a person of ordinary skill in the art that these specific details need not be employed, and should not be construed to limit the scope of the subject matter.

In the development of any actual implementation, numerous implementation-specific decisions must be made to achieve the developer's specific goals, such as compliance with system-related and business-related constraints. Such a development effort might be complex and time-consuming, but may nevertheless be a routine undertaking of design, fabrication, and manufacture for those of ordinary skill. Hence as various changes could be made in the above constructions without departing from the scope of the invention, it is intended that all matter contained in the above description or shown in the accompanying drawings shall be interpreted as illustrative and not in a limiting sense.

The foregoing description of embodiments is provided to enable any person skilled in the art to make and use the invention. Various modifications to these embodiments will be readily apparent to those skilled in the art, and the novel principles and invention disclosed herein may be applied to other embodiments without the use of the innovative faculty. It is contemplated that additional embodiments are within the spirit and true scope of the disclosed subject matter.

What is claimed is:

1. I claim all of the above subject matter.
